(19) United States
(12) Patent Application Publication
(10) Pub. No.: US 2009/0024960 A1
(43) Pub. Date: Jan. 22, 2009

(54) ELECTRONIC BALANCE

(75) Inventor: Hiroshi Hamamoto, Kyoto (JP)

Correspondence Address: SUGHRUE MION, PLLC, 2100 PENNSYLVANIA AVENUE, N.W., SUITE 800, WASHINGTON, DC, 20037, US

(73) Assignee: Shimadzu Corporation, Kyoto-shi, Kyoto (JP)

(21) Appl. No.: 12/280,710

(22) PCT Filed: Mar. 23, 2006
(86) PCT No.: PCT/JP2006/305792

§ 371 Date: Aug. 26, 2008

(51) Int. Cl. G06F 3/048

(52) U.S. Cl. 715/810

(57) ABSTRACT

In the electronic balance according to the present invention, in the menu list in which basic menu list information wherein predetermined many menu items are tree-structured and user menu list information stored in a nonvolatile memory when a user registers at will a calculation function or other functions which the user frequently uses are incorporated, it is possible to select an intended menu item, by moving in the same layer and moving to the lower layer step by step in accordance with a predetermined key operation. Since the setting/cancellation of the menu item, e.g. the function 8, that the user often uses is provided in the lower layer of my menu which has a high priority, it is possible to select it with a small number of key operations compared to the case where the selection is performed by following the tree structure step by step, e.g. from the menu group 2 to the function 8. This increases the efficiency of the operation, and since the operation is simple, the user can operate without referring to an operation manual. Since no change of the order or the like occurs in the basic menu list other than the user menu list 29, it is possible to perform the selection of the menu item in such a list with a conventional operation.

### TECHNICAL FIELD

The present invention relates to an electronic balance, and more precisely, to an electronic balance which has a select function for menu items such as the selection of measurement, sensitivity calibration, and calculation function. The electronic balance in this invention includes an electronic scale for generally measuring a weight greater than that measured by a normal electronic balance.

### BACKGROUND ART

The basic function of an electronic balance is to determine a measurement value by performing an averaging procedure or other procedure in an arithmetic processor to load data from a load detector on which an object to be measured is put, and to display the measurement value on a display. The arithmetic condition, such as data averaging time, performed by the arithmetic processor generally includes a plurality of prepared conditions, and a user can select them at will in accordance with the installation environment of a balance, the purpose and use of it, etc. In addition, such recent electronic balances include various functions, and the arithmetic processor is designed for performing arithmetic processes corresponding to such functions.

For example, the arithmetic processor determines whether or not the load data obtained at predetermined intervals is stable, and in accordance with the result, displays information to let the user know that the measured value is stable enough to be read off. The condition for this stability determination can be selected from a plurality of conditions. Furthermore, it is possible to select, in addition to a normal measurement mode, what is called a sensitivity calibration mode for performing a sensitivity calibration using load data obtained by loading a known mass such as a reference weight onto the load detector. Moreover, some electronic balances additionally include a function for changing the measurement result on the gram scale into a display value of various units such as ounces and carats, or a function for performing a judgment of acceptance in a measuring out operation.

As just described, recent electronic balances have become extremely multifunctionalized and a user sets and cancels various functions according to necessity. On the other hand, it is difficult to increase the number of key switches since there is a demand for reducing costs as much as possible and a problem on a design for downsizing. Given this factor, the selection of each calculation function and selection of the calculation condition in each calculation function as previously described are designed to be performable by combining the operations of the key switches for performing a basic measurement.

Specifically speaking, as disclosed in Patent Documents 1 and 2, numerous menu items (more than 100 items in the case where they are many) such as various calculation functions and calculation conditions in each of the functions are organized in a hierarchical (tree) structure with a plurality of layers as illustrated in FIG. 2 for example. A few key switches are assigned to function to move within the same layer and move to the lower layer or upper layer in this tree structure. If the user operates the key switches in a designated order, it is possible to sequentially follow the menu items in the tree structure and eventually reach the intended function setting/cancellation, condition setting, etc, to perform the setting or cancellation thereof.

However, since in the first place the selection of a variety of menu items is enabled with a small number of key switches, in some cases a considerable number of key operations are required in order to set/cancel the desired function and condition. In addition, since the tree structure of the menu items gets increasingly more intricate with a growing number of functions, it is difficult for the user of the electronic balance to remember the operating procedure, and an operation manual or guide is required every time a menu operation is performed. For this reason, not only is the working efficiency low, but also the operation itself is painful for those who are unfamiliar with the operation of such apparatuses. Moreover, in some cases, the user may erroneously perform an unintended function setting/cancellation, which might cause a problem for an accurate measurement.

[Patent document 1] Japanese Unexamined Patent Application Publication No. H8-304151

[Patent document 2] Japanese Unexamined Patent Application Publication No. H10-307056

### DISCLOSURE OF THE INVENTION

### Problems to be Solved by the Invention

The efforts to eliminate the complexity of the operation as previously described have been made also in the electronic balances described in Patent Documents 1 and 2. For example, in the electronic balance described in Patent Document 1, a menu code corresponding to the function which has been used before is memorized, and then if a user performs a specified key operation, a function corresponding to the menu code can be directly called. In the electronic balance described in Patent Document 2, the order of menu items in a tree structure is changed through a specified key operation, which enables the number of the key operations to be decreased for selecting a frequently-used function.

However, the former method has a disadvantage in that a user has to perform a nonstandard specified key operation every time he or she uses this balance, which easily causes an operational error. In addition, although this method may be good in the case where the number of users is one, it cannot support the case where a plurality of users share the balance and where the functions that each user often uses differ. The latter method has a disadvantage in that the order of the menu items in the tree structure may possibly change frequently, which may confuse an inexperienced user with operating by contrast. In particular, in the case where the number of users is more than one and the functions that each user often uses differ, it is highly possible that this method may decrease the usability by contrast.

The present invention is achieved to solve the previously-described problems and the purpose thereof is to provide an electronic balance capable of assuredly performing a setting/cancellation of the desired function or setting of conditions by a user with a simple operation, particularly capable of achieving a good operability even in the case where it is shared by a plurality of users.

### Means for Solving the Problems

To solve the previously-described problem, a first aspect of the present invention provides an electronic balance for performing an averaging procedure on data obtained in a load detector by an arithmetic processor to determine a measurement value and for displaying it on a display, and the electronic balance being capable of, regarding a menu list in which menu items for setting/cancelling various functions including a selection of a calculation function performed by the arithmetic processor and a setting of a condition for performing the function are tree-structured, selecting an intended menu item by following the tree structure step by step through an operation of a key switch, including:

a) a register means for allowing a user to set and register at will a menu item which is reached by following a tree structure step by step regarding a basic menu list which is set in advance;

b) a rewritable memory for storing an information content registered by the register means and being capable of holding a memory content even in a power-off state; and

c) a menu setting controller for, in a case where registered information is held in the memory, virtually creating a menu list in which the information is incorporated as a user menu list with the basic menu list, and for allowing a selection of a menu item by following the tree structure of the menu list in accordance with an operation of the key switch.

In the electronic balance according to the first aspect of the present invention, the menu list may preferably have a tree structure in which a menu item in the user menu list is selected in preference to a menu item in the basic menu list.

The electronic balance according to the present invention may be preferably configured so that each of a plurality of users can set and register a different user menu list.

A second aspect of the present invention to solve the previously-described problem provides an electronic balance for performing an averaging procedure on data obtained in a load detector by an arithmetic processor to determine a measurement value and for displaying it on a display, and the electronic balance being capable of, regarding a menu list in which menu items for setting/cancelling various functions including a selection of a calculation function performed by the arithmetic processor and a setting of a condition for performing the function are tree-structured, selecting an intended menu item by following the tree structure step by step through an operation of a key switch, including:

a) a register means for allowing a user to previously set and register at will an unnecessary menu item;

b) a rewritable memory for storing information registered by the register means and being capable of holding a memory content even in a power-off state; and

c) a menu setting controller for, in following the tree structure regarding the menu list step by step in accordance with an operation of a key switch, changing menu items to be selected, based on the information stored in the memory, in order to pass on the unnecessary menu item.

### EFFECTS OF THE INVENTION

In the electronic balance according to the first aspect of the present invention, a user registers a menu item, through the register means, for setting/cancelling the function that he or she frequently uses and the condition regarding thereof among a number of menu items in the basic menu list. Since the information registered as just described is stored in the memory, the information will be held if the electrical balance's power is shut off. After that, when the user operates the key switch to select the menu item, the menu setting controller virtually creates a menu list in which a user menu list based on the registered information and the basic menu list are incorporated, and changes the selection of the menu item in accordance with each operation of the key switch by following the tree structure of the menu list.

Hence, if the tree structure is configured so that a menu item in the user menu list is preferentially selected to a menu item in the basic menu list, e.g. so that a menu item for specifying the user menu list is placed in the first place in the highest layer of the basic menu list, the number of operations of the key switch until selecting a desired menu item can be more decreased than before. At the same time, the tree structure itself of the basic menu list is not changed. Hence, in the case where the user tries to select a menu item other than those registered in the user menu list, although the number of operations of the key switch itself may be increased with the addition of the user menu list, the operating procedure itself is basically not different from the conventional procedure. Therefore, the user will not be confused with the operation.

As just described, with the electronic balance according to the first aspect of the present invention, it is possible to easily select a menu item (calculation function) frequently used with a less number of key operation than before, and perform the setting and cancellation of the function for example. Therefore, it is possible to efficiently perform a measurement operation using an electronic balance and prevent an inaccurate measurement arising from a mistake in setting or other reasons. In addition, since the menu item frequently used in the user menu list can be selected with a simple operation, the user can perform the operation without using an operation manual, guide, etc.

With the configuration in which each of a plurality of users can set and register a different user menu list, even in the case where the plural users share one electronic balance and each user's usage, e.g. calculation functions used and conditions for each function, differs, each user can select an intended menu item with a small number of key operations using the user menu list that the user himself or herself has set in advance. Therefore, the electronic balance is easy to use for every user and errors, such as erroneously selecting a menu item that other users have registered, do not easily occur.

On the other hand, in the electronic balance according to the second aspect of the present invention, the user determines menu items which are not possible to be used in the menu list and registers them in advance through the register means. As in the first aspect of the present invention, the registered information is stored in the memory. After that, when the user operates the key switch to select the menu item, the menu setting controller changes the selection of the menu item in accordance with the operation of the key switch by following the tree structure, while skipping the unnecessary menu items as if they do not exist in the menu list.

Hence, with the electronic balance according to the second aspect of the present invention, the menu list is apparently (and in the operation of the key switch) simplified. Accordingly, the number of key operations until reaching the intended menu item by following the tree structure is reduced, which is advantageous in enhancing the efficiency of the measurement operation. Additionally, since the operation for selecting the menu item is simplified, the user can avoid the necessity of referring to an operation manual or guide.

### BRIEF DESCRIPTION OF THE DRAWINGS

FIG. 1 is a block diagram illustrating a schematic configuration of the electronic balance according to the first embodiment of the present invention.

FIG. 2 is a pattern diagram illustrating an example of the tree structure of a basic menu list stored in a ROM in the electronic balance according to the first embodiment.

FIG. 3 is a pattern diagram illustrating the tree structure of the menu list in which a basic menu list stored in a ROM and a user menu list stored in a nonvolatile memory are incorporated.

FIG. 4 illustrates an example of a tree structure in the case where a user has added menu items in the user menu list of the menu list of FIG. 3.

FIG. 5 is a block diagram illustrating a schematic configuration of the electronic balance according to the second embodiment of the present invention.

FIG. 6 is a pattern diagram illustrating an example of the tree structure of a menu list to be operated in the electronic balance according to the second embodiment.

### BEST MODES FOR CARRYING OUT THE INVENTION

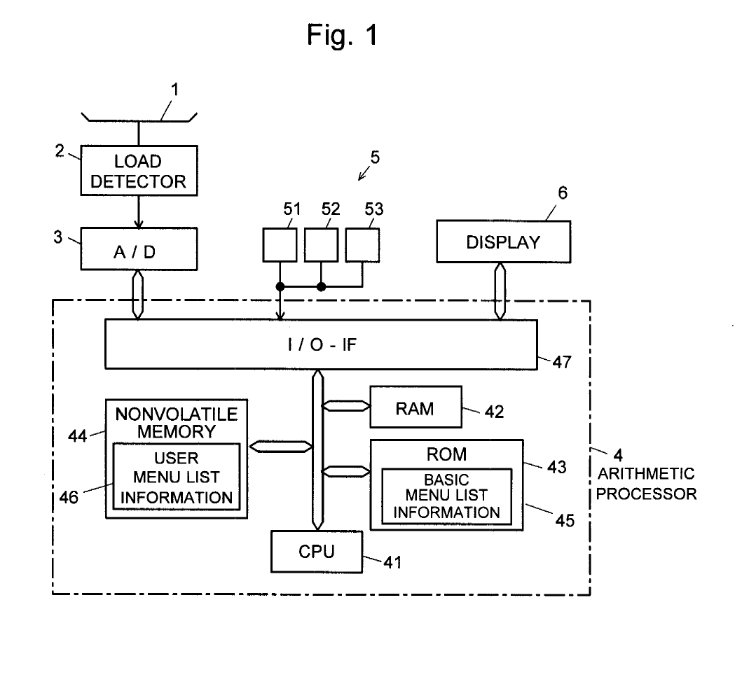

Hereinafter, a first embodiment of the electronic balance according to the present invention will be explained with reference to the drawings. FIG. 1 is a schematic configuration diagram of the electronic balance according to the first embodiment.

The load detector 2 incorporates an electromagnetic force-balanced type balance mechanism in which the load of an object to be measured put on the tray 1 and electromagnetic force generated are balanced for example, and generates an electric signal corresponding to the load on the tray 1 based on the null method. An analog output signal from the load detector 2 is converted to digital data in the analog/digital (A/D) converter 3, and then is read into an arithmetic processor 4 at predetermined sampling time intervals. The arithmetic processor 4 is configured centering around a microcomputer and includes a central processing unit (CPU) 41, a random access memory (RAM) 42, a read only memory (ROM) 43, a rewritable nonvolatile memory 44 such as a flash memory, and an input/output interface (I/O-IF) 47. In addition to the A/D converter 3, a key switch group 5, and a display 6 for showing a measurement value and a display corresponding to the menu items which will be described later are connected by way of the input/output interface 47.

In the ROM 43 of the arithmetic processor 4, in addition to a basic program for controlling the operation of each unit, arithmetic programs corresponding to each of the plural menu items are written. A program for selecting each of the arithmetic programs is also written as basic menu list information 45. The RAM 32 is configured with a data buffer area for storing load data periodically fed at predetermined time intervals as previously described, a work area appropriately used in the arithmetic process, and other areas. Furthermore, in the nonvolatile memory 44, a program, in which data is appropriately added or deleted in accordance with a user's operation as will be described later, for selecting an arithmetic program is written as user menu list information 46.

The key switch group 5 includes a power on/off key 51, a tare key 52, a sensitivity calibration key 53, and other keys. The basic function of these keys are as follows: the power on/off key 51 is literally a key switch for activating or cutting the power of the electronic balance, the tare key 52 is a key switch for subtracting the tare weight (e.g. 10 g), which is previously determined, when performing a measurement, the sensitivity calibration key 53 is a key switch operated in order to perform a sensitivity calibration of a measurement value with a reference weight on the tray 1. Although there are some key switches other than these, their explanation is omitted in the present description.

Although the basic function of the three key switches 51, 52, and 53 are as previously described, these are also used for a menu operation. In the menu operation, the function as follows is assigned to each of the key switches 51, 52, and 53. That is, the function for quitting the menu operation mode is assigned to the power on/off key 51, the function for selecting a menu group (moving into a lower layer) and for performing a setting/cancellation of a function to the tare key 52, and the function for moving into the menu operation mode from a weight display and for changing the menu group and functions to the sensitivity calibration key 53. In the meantime, regarding the menu operation, each of these keys will be respectively and newly called a break key 51, enter key 52, and menu key 53.

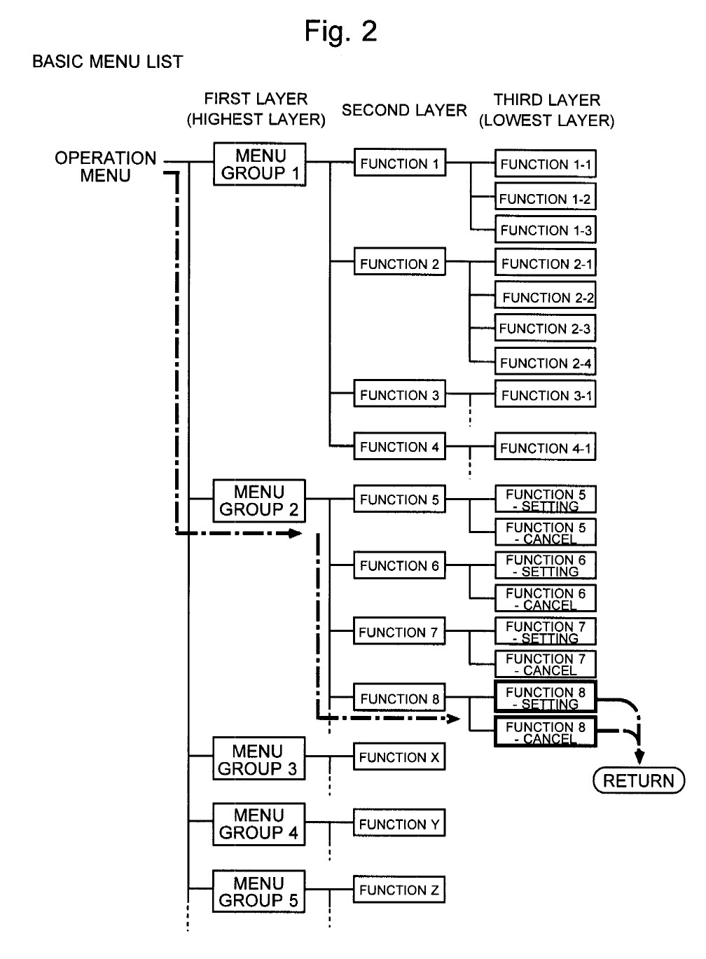

FIG. 2 is a pattern diagram illustrating the data structure of the basic menu list information 45 which is written in the ROM 33. As illustrated, the basic menu list has a tree structure composed of three layers. In the highest layer (the first layer), menu items (menu groups 1 through 5 in this example) each indicating a menu group are provided, in the next layer (the second layer) which is below each menu group, menu items each indicating a plurality of functions are provided, and in the lowest layer (the third layer) which is the next layer below each of the menu items, menu items indicating further segmentalized functions and the setting or cancelling the function of the second layer are provided. Since every menu item is tree-structured under the operation menu, an intended menu item is selected by operating the three keys, from all the menu items in the menu list, by moving within the same layer or moving to the lower layer from the highest layer in order. Then, in accordance with the selection result, from the arithmetic programs stored in another area in the same ROM 33, the pertinent one is read out to be executed on the CPU 41.

As an example, at this point, in the case where the aforementioned basic menu list is used, the procedure will be explained in performing the setting and cancellation of the “FUNCTION 8” in the menu group 2 from the state of a weight display. In the normal weight display state, the user operates the menu key 53 to move from the weight display state to the menu operation mode. One more operation of the menu key 53 moves the selected menu item from the menu group 1 to 2 in the highest layer, and with one operation of the enter key 52 at this point, the menu group 2 is selected to move to the lower layer.

With every single operation of the menu key 53, the selected menu item moves in a transverse direction (downwards in FIG. 2) one by one on the second layer. Hence, the user presses the menu key 53 three times to move to the menu item of “FUNCTION 8” and then operates the enter key 52 once to select the “FUNCTION 8” to move to the lower layer (the third layer).

In this state, the selected menu item is “FUNCTION 8—SETTING.” Hence, in order to perform the setting of the function 8, the enter key 52 is pressed once. On the other hand, in order to perform the cancellation of the function 8, the menu key 53 is operated once to move the selected menu item to the menu item of “FUNCTION 8—CANCEL” and the enter key 52 is operated once. In order to terminate the menu operation mode after the setting or cancellation of the function 8 as just described, the break key 51 is operated once.

As previously described, it takes nine total key operations in order to set the function 8 from the weight display state and return to the original state, and it takes ten total key operations in order to cancel the setting of the function 8 from the weight display state and return to the original state. As a matter of course, the number of operations is not fixed, since the higher the menu item to be selected is located in the same layer in FIG. 2, the smaller the number of key operations is required. In addition, although there are only three layers in the example of FIG. 2, if the functions are more intricate, the number of layers will be more increased. In such a case, the number of operations may possibly be further increased.

It is troublesome to perform a number of key operations as previously described every time the setting/cancelation of the intended function as just described is performed. In some cases, the setting/cancelation of the other function might be erroneously and unintentionally performed. Given this factor, the present embodiment has a characteristic function that a menu item frequently used is registered in advance so that an intended function can be selected to set or cancelled with a small number of key operations.

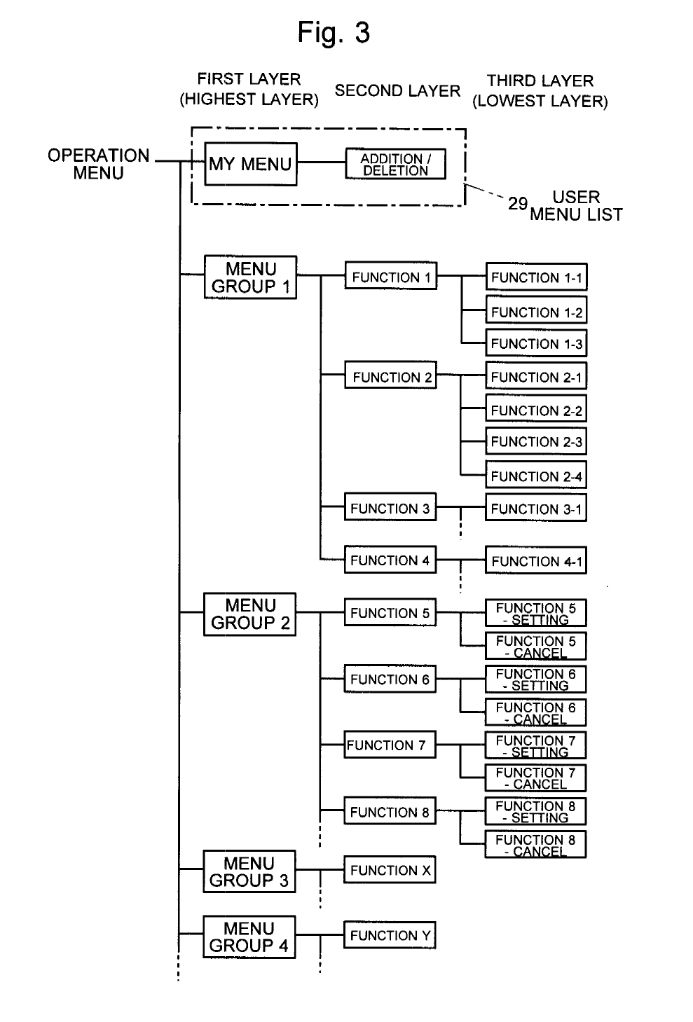

That is, in the electronic balance according to the present embodiment, in the user menu list information 46 which is initially written in the nonvolatile memory 44, a menu item for specifying the addition/deletion is connected under the menu item of “MY MENU” as illustrated in FIG. 3. A virtual integrated menu list is structured so that the “MY MENU” in the user menu list 29 has a priority to the menu group 1 of the highest layer in the basic menu list by incorporating both the menu lists. Although nothing is registered in the “MY MENU” in such an initial state, the user at will can add a plurality of menu items parallel to the second layer of the “MY MENU” by operating the key switch.

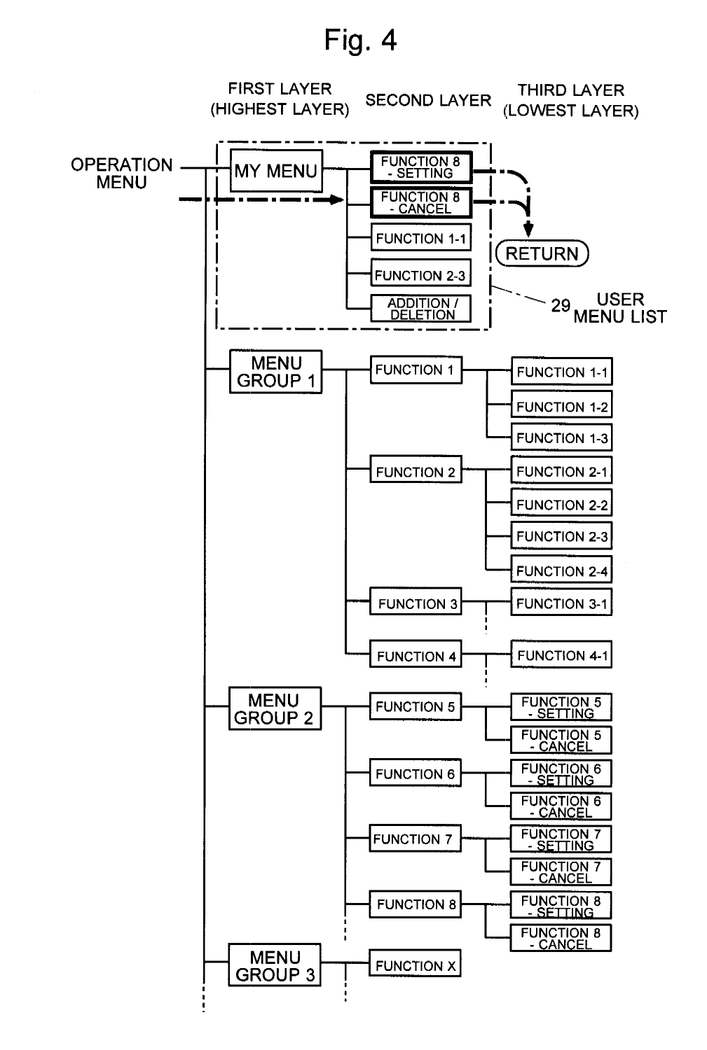

That is, if the user operates the menu key 53 to move to the menu operation mode and further operates the menu key 53 to select the “MY MENU,” it is possible to perform the addition/deletion of the menu item. In this example, the addition is selected and frequently-used functions are selected from the function list of the basic menu list. In this example, four functions of “FUNCTION 8-SETIING”, “FUNCTION 8—CANCEL”, “FUNCTION 1-1”, and “FUNCTION 2-3” are sequentially selected. With this selection, the data tree-structured as illustrated by the user menu list 29 in FIG. 4 is constructed, and this information is written in the user menu list 46 of the nonvolatile memory 44. Since the information 46 will not be deleted as long as it is not rewritten, if a setting is done once, it can be used at any time. Since the registration operation of the menu item as previously described is achieved by performing the predetermined program, which is written in the ROM 43, on the CPU 41, the register means of the present invention may be the CPU 41, ROM 43 (also the RAM 42 in some cases), and other units, and the memory may be the nonvolatile memory 44.

In the state where the user menu list information 46 as previously described is registered, in the menu operation mode, a menu list having a tree structure as illustrated in FIG. 4 is virtually structured by integrating the user menu list information 46 and the basic menu list information 45. That is, although the user menu list information 46 and the basic menu list information 45 are stored in different memories, they are treated as combined in the menu operation mode. The operational procedure to perform the setting/cancelling of the same function 8 as previously described under the menu list is as follows.

In the normal weight display mode, the user operates the menu key 53 once to move from the normal weight mode to the menu operation mode, and operates the enter key 52 once to select the “MY MENU” in the first layer to move onto the second layer. Then the user operates the enter key 52 once to select “FUNCTION 8—SETTING.” On the other hand, in order to cancel the setting of the function 8, the menu key 53 is operated once to move the menu item to the next in the second layer, and after that the enter key 52 is operated once. In order to terminate the menu operation mode after the setting or cancellation of the function 8 as just described to return to the weight display, the break key 51 is operated once.

Therefore, in the case where the user menu list 29 is used, four key operations are required for the setting of the function 8 and five key operations for cancelling the setting of the function 8. The number of key operations is decreased approximately to half in the case where the selection of the setting/cancelation of the function 8 according only to the basic menu list as stated earlier. Since the selection operation of the menu item as just described is achieved by performing a predetermined program, which is written in the ROM 43, on the CPU 41, the menu setting controller according to the present invention may be the CPU 41, ROM 43 (also the RAM 42 in some cases), and other units.

As is clear from the previously-described explanation, the number of key operations also depend on the location of the menu item to be selected in the second layer in the user menu list 29. Therefore, it is preferable to perform a registration so that the function used more frequently is placed in the upper portion of the second layer.

The menu item of the my menu is only one in the aforementioned example. However, in the case where a plurality of users use the electronic balance and each user uses a different calculation function, it is inconvenient for the plurality of users to use a common my menu. Given this factor, a plurality of user menu lists may be registered and when a user enters a password for example, the user menu list corresponding to the password may be used. With this configuration, since a person other than a certain user who has registered a my menu does not rewrite the content as he or she pleases, the user can always use the user menu list that he or she has registered and perform the setting of the menu item.

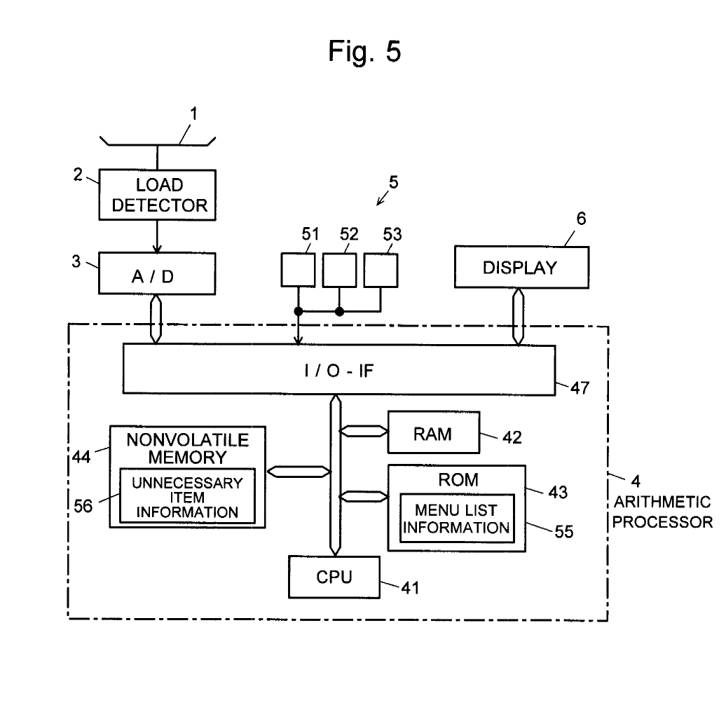

Next, an electronic balance according to the second embodiment of the present invention will be explained with reference to the drawings. FIG. 5 is a schematic configuration diagram of the electronic balance according to the second embodiment, and the same or corresponding components as in the first embodiment are indicated with the same numerals and the explanations are omitted. As is clear from FIG. 5, the basic configuration is the same as that of the electronic balance according to the first embodiment; hence, only significantly different points will be explained.

In the ROM 43 of the arithmetic processor 4, menu list information 55 is written which is substantially the same as the basic menu list information in the first embodiment. The reason why “basic” is not put on it is because other menu lists such as a user menu list do not exist in this example. The nonvolatile memory 44 has an area for writing unnecessary item information 56.

In the electronic balance according to the second embodiment, a menu item that has no possibility of being used is registered among a number of menu items included in the menu list, in accordance with the procedure as the user has registered in advance the information corresponding to the user menu list in the electronic balance according to the first embodiment. This information is written in the nonvolatile memory 44 as the unnecessary item information 56. Once this information is written, it will be held until it is rewritten or totally eliminated at will by the user.

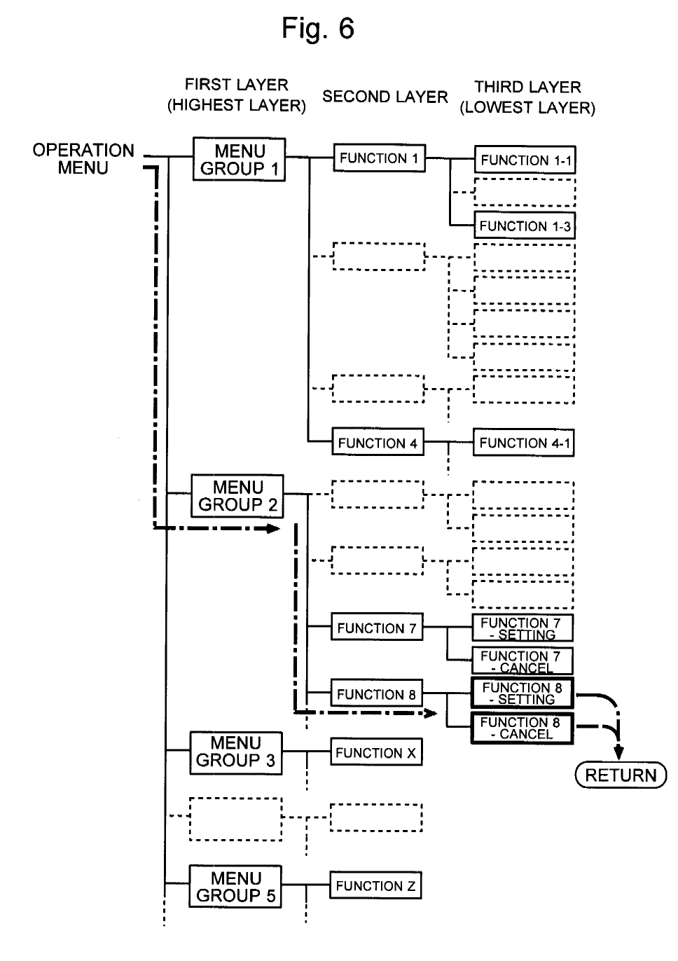

In the state where the unnecessary item information 56 is registered as previously described, in the menu operation mode, a menu list having a tree structure as illustrated in FIG. 6 is virtually structured. In this figure, the menu items illustrated with a dashed line are the menu items registered in the unnecessary item information 56. However, the menu items illustrated with a dashed line in this figure do not disappear in the menu list information 55; in reality, when the selected menu item moves within the same layer or moves to a lower layer in the tree structure in accordance with the operation of the key switches 51, 52, and 53, whether the menu item targeted is registered or not in the unnecessary item information 56 is checked. In the case where it is registered in the unnecessary item information 56, the menu item is passed on, regarded to be nonexistent to be more precise, to move on to the next destination.

The operational procedure to perform the setting/cancellation of the same function 8 as previously described under the menu list in which some menu items are virtually eliminated is as follows.

In the normal weight display state, the user operates the menu key 53 once to move from the weight display state to the menu operation mode. With one more operation of the menu key 53, the selected menu item moves from the menu group 1 to 2 in the highest layer, and with one operation of the enter key 52 at this point, the menu group 2 is selected to move onto the lower layer. However, when the selected menu item is moved to the lower layer, the destination is the “FUNCTION 7,” since the “FUNCTION 5” and “FUNCTION 6” which are existent in FIG. 2 are virtually nonexistent in this embodiment. If the user operates the menu key 53 only once, the selected menu item moves to the menu item of the “FUNCTION 8.” Then one operation of the enter key 52 is performed to select the “FUNCTION 8” to move to the lower layer (the third layer).

In this state, the selected menu item is “FUNCTION 8—SETTING.” Hence, in order to perform the setting of the function 8, the enter key 52 is pressed once. On the other hand, in order to perform the cancellation of the function 8, the menu key 53 is pressed once to move the selected menu item to the menu item of “FUNCTION 8—CANCEL” and the enter key 52 is pressed once. In order to terminate the menu operation mode after the setting or cancellation of the function 8 as just described, the break key 51 is operated once. This operation is identical as before.

In the aforementioned example, since the menu items of the “FUNCTION 5” and “FUNCTION 6” in the second layer are virtually nonexistent, two key operations are decreased. Hence, only seven total key operations are required in order to set the function 8 from the weight display state to return to the original state, and eight total key operations in order to cancel the setting of the function 8 from the weight display state and return to the original state. Of course, if the number of menu items set to be unnecessary is decreased, that is to say, if the number of available menu items is decreased, a smaller number of key operations will be required. It is probable that a calculation function which has been considered not to be used may be necessary; in such cases, it is preferable that a reset may be performed through a predetermined key operation in order to totally erase the unnecessary item information 56 and to reset the menu list to the initial state.

Also in this embodiment, different unnecessary item information may be set for each of the plural users so that the menu item which can be normally used may be changed for each user.

It should be noted that every example thus far is merely an example, and it is evident that any modification, adjustment or addition properly made within the spirit of the preset invention is also covered within the scope of the present invention.

1. An electronic balance for performing an averaging procedure on data obtained in a load detector by an arithmetic processor to determine a measurement value and for displaying it on a display, and the electronic balance being capable of, regarding a menu list in which menu items for setting/cancelling various functions including a selection of a calculation function performed by the arithmetic processor and a setting of a condition for performing the function are tree-structured, selecting an intended menu item by following the tree structure step by step through an operation of a key switch, comprising:
a) a register means for allowing a user to set and register at will a menu item which is reached by following a tree structure step by step regarding a basic menu list which is set in advance;
b) a rewritable memory for storing an information content registered by the register means and being capable of holding a memory content even in a power-off state; and
c) a menu setting controller for, in a case where registered information is held in the memory, virtually creating a menu list in which the information is incorporated as a user menu list with the basic menu list, and for allowing a selection of a menu item by following the tree structure of the menu list in accordance with an operation of the key switch.

2. The electronic balance according to claim 1, wherein the menu list has a tree structure in which a menu item in the user menu list is selected in preference to a menu item in the basic menu list.

3. The electronic balance according to claim 1, wherein each of a plurality of users can set and register a different user menu list.

4. An electronic balance for performing an averaging procedure on data obtained in a load detector by an arithmetic processor to determine a measurement value and for displaying it on a display, and the electronic balance being capable of, regarding a menu list in which menu items for setting/cancelling various functions including a selection of a calculation function performed by the arithmetic processor and a setting of a condition for performing the function are tree-structured, selecting an intended menu item by following the tree structure step by step through an operation of a key switch, comprising:
a) a register means for allowing a user to previously set and register at will an unnecessary menu item;
b) a rewritable memory for storing information registered by the register means and being capable of holding a memory content even in a power-off state; and
c) a menu setting controller for, in following the tree structure regarding the menu list step by step in accordance with an operation of a key switch, changing menu items to be selected, based on the information stored in the memory, in order to pass on the unnecessary menu item.

5. The electronic balance according to claim 2, wherein each of a plurality of users can set and register a different user menu list.

6. The electronic balance according to claim 4, wherein each of a plurality of users can set and register different unnecessary item information.
